(19) United States
(12) Patent Application Publication
(10) Pub. No.: US 2026/0079488 A1
(43) Pub. Date: Mar. 19, 2026

(54) PROCESSING SYSTEM, PROCESSING METHOD, AND STORAGE MEDIUM THEREOF

(71) Applicant: DENSO CORPORATION, Kariya-city (JP)

(72) Inventors: TADAYUKI YOKOTA, Kariya-city (JP); TEIYU KIMURA, Kariya-city (JP); KEI NAKANO, Kariya-city (JP); YUKO KANDA, Kariya-city (JP)

(21) Appl. No.: 19/400,795

(22) Filed: Nov. 25, 2025

Related U.S. Application Data
(63) Continuation of application No. PCT/JP2024/015344, filed on Apr. 18, 2024.

(30) Foreign Application Priority Data
May 29, 2023 (JP) 2023-087917

(51) Int. Cl. G05D 1/224; G05D 1/686; G05D 105/70; G06T 19/00

(52) U.S. Cl. CPC G05D 1/2249; G05D 1/686; G06T 19/006; G05D 2105/70

(57) ABSTRACT

A processing system includes at least one processor, which is configured to: acquire a required content of user service; acquire service capability information representing provision capabilities of the user service, which are associated with autonomous traveling devices waiting in a visual field area visually recognized by the user through a wearable terminal worn by the user; search for a target autonomous traveling device whose provision capability matches the required content among the provision capabilities represented by the service capability information for the respective autonomous traveling devices in the visual field area; display, in a superimposed manner, an XR enhanced image, which highlights the target autonomous traveling device, on the visual field area; and provide the user service by driving, within the visual field area, the target autonomous traveling device selected by the user in response to superimposed display of the XR enhanced image.

### CROSS-REFERENCE TO RELATED APPLICATION(S)

The present application is a continuation application of International Patent Application No. PCT/JP2024/015344 filed on Apr. 18, 2024, which designated the U.S. and claims the benefit of priority from Japanese Patent Application No. 2023-087917 filed on May 29, 2023. The entire disclosures of all of the above applications are incorporated herein by reference.

### TECHNICAL FIELD

The present disclosure relates to a processing technology for performing service-related processing for providing a service to a user.

### BACKGROUND

There has been known a service providing system that divides a route for providing a guidance service to a user with use of autonomous traveling devices into multiple service ranges, and then reserves one of the autonomous traveling devices corresponding to the service providable range, thereby appropriately providing a guidance to the user.

### SUMMARY

According to an aspect of the present disclosure, a processing system is provided for performing a service related processing. The service related processing is related to a user service to be provided to a user. The processing system includes at least one processor with a memory storing computer program code. The at least one processor with the memory may be configured to: acquire a required content of the user service required by the user; acquire service capability information representing provision capabilities of the user service, the provision capabilities being associated with autonomous traveling devices waiting in a visual field area visually recognized by the user through a wearable terminal worn by the user; search for a target autonomous traveling device whose provision capability matches the required content among the provision capabilities represented by the service capability information for the respective autonomous traveling devices in the visual field area; display, in a superimposed manner, an extended reality (XR) enhanced image, which highlights the target autonomous traveling device, on the visual field area; and provide the user service by driving, within the visual field area, the target autonomous traveling device selected by the user in response to superimposed display of the XR enhanced image.

### BRIEF DESCRIPTION OF DRAWINGS

The present disclosure will become apparent from the following detailed description made with reference to the accompanying drawings. In the drawings:

FIG. 1 is an overall configuration diagram illustrating a network connection environment of a processing system according to a first embodiment;

FIG. 2 is a schematic diagram illustrating a wearable terminal according to the first embodiment;

FIG. 3 is a schematic diagram illustrating three-dimensional voxels assumed in an infrastructure system according to the first embodiment;

FIG. 4 is a block diagram illustrating the processing system according to the first embodiment;

FIG. 5 is a flowchart illustrating a processing flow according to the first embodiment;

FIG. 6 is a flowchart illustrating the processing flow according to the first embodiment;

FIG. 7 is a schematic diagram illustrating a display state of the wearable terminal according to the first embodiment;

FIG. 8 is a schematic diagram illustrating a display state of the wearable terminal according to the first embodiment;

FIG. 9 is a schematic diagram illustrating a display state of the wearable terminal according to the first embodiment;

FIG. 10 is an overall configuration diagram illustrating a network connection environment of a processing system according to a second embodiment;

FIG. 11 is a schematic diagram illustrating a mobile terminal according to the second embodiment;

FIG. 12 is a block diagram illustrating the processing system according to the second embodiment;

FIG. 13 is a flowchart illustrating a processing flow according to the second embodiment;

FIG. 14 is a flowchart illustrating the processing flow according to the second embodiment;

FIG. 15 is a schematic diagram illustrating a display state of the mobile terminal according to the second embodiment;

FIG. 16 is a schematic diagram illustrating a display state of the mobile terminal according to the second embodiment;

FIG. 17 is a schematic diagram illustrating a display state of the wearable terminal according to a modification of the first embodiment; and

FIG. 18 is a schematic diagram illustrating a display state of the wearable terminal according to the modification of the first embodiment.

### DETAILED DESCRIPTION

In the above-described service providing system, the autonomous traveling device corresponding to the service providable range is automatically reserved in the divided service range. Thus, it is difficult to reflect the request made by the user in the reservation. However, the reflection of the user request is not limited to the guidance service, and becomes a particularly necessary factor in providing the user service of diversified content by the autonomous traveling device, but makes the search for the autonomous traveling device complicated.

According to a first aspect of the present disclosure, a processing system is provided for performing a service related processing. The service related processing is related to a user service to be provided to a user. The processing system includes at least one processor with a memory storing computer program code. The at least one processor with the memory may be configured to: acquire a required content of the user service required by the user; acquire service capability information representing provision capabilities of the user service, the provision capabilities being associated with autonomous traveling devices waiting in a visual field area visually recognized by the user through a wearable terminal worn by the user; search for a target autonomous traveling device whose provision capability matches the required content among the provision capabilities represented by the service capability information for the respective autonomous traveling devices in the visual field area; display, in a superimposed manner, an extended reality (XR) enhanced image, which highlights the target autonomous traveling device, on the visual field area; and provide the user service by driving, within the visual field area, the target autonomous traveling device selected by the user in response to superimposed display of the XR enhanced image.

According to a second aspect of the present disclosure, a processing method is executed by at least one processor to perform service related processing. The service related processing is related to a user service provided to a user. The processing method includes: acquiring a required content of the user service required by the user; acquiring service capability information representing provision capabilities of the user service, the provision capabilities being associated with autonomous traveling devices waiting in a visual field area visually recognized by the user through a wearable terminal worn by the user; searching for a target autonomous traveling device whose provision capability matches the required content among the provision capabilities represented by the service capability information for the respective autonomous traveling devices in the visual field area; displaying, in superimposed manner, an extended reality (XR) enhanced image, which highlights the target autonomous traveling device, on the visual field area; and providing the user service by driving, within the visual field area, the target autonomous traveling device selected by the user in response to superimposed display of the XR enhanced image.

According to a third aspect of the present disclosure, a computer readable non-transitory storage medium stores a program including instructions to perform service related processing. The service related processing is related to a user service provided to a user. The instructions includes: acquiring a required content of the user service required by the user; acquiring service capability information representing provision capabilities of the user service, the provision capabilities being associated with autonomous traveling devices waiting in a visual field area visually recognized by the user through a wearable terminal worn by the user; searching for a target autonomous traveling device whose provision capability matches the required content among the provision capabilities represented by the service capability information for the respective autonomous traveling devices in the visual field area; displaying, in superimposed manner, an extended reality (XR) enhanced image, which highlights the target autonomous traveling device, on the visual field area; and providing the user service by driving, within the visual field area, the target autonomous traveling device selected by the user in response to superimposed display of the XR enhanced image.

As described above, according to the first to third aspects of the present disclosure, the service capability information representing the provision capabilities of the user service, which are associated with the autonomous traveling devices waiting in the visual field area to be visually recognized by the user, is acquired through the wearable terminal worn by the user. Therefore, when the required content of the user service required by the user is acquired, attention is paid to an autonomous traveling device whose provision capability matches the required content among provision capabilities represented by the service capability information for the respective autonomous traveling devices in the visual field area. Accordingly, the XR enhanced image in which the target autonomous traveling device whose capability matches the required content is highlighted is displayed in a superimposed manner in the visual field area for the selection of the device made by the user. Therefore, it is possible to improve the search efficiency of the autonomous traveling device capable of providing the user service satisfying the user request by being driven in the visual field area.

According to a fourth aspect of the present disclosure, a processing system is provided for performing a service related processing. The service related processing is related to a user service provided to a user. The processing system includes at least one processor with a memory storing computer program code. The at least one processor with the memory is configured to: acquire a required content of the user service required by the user; acquire service capability information representing provision capabilities of the user service, the provision capabilities being associated with autonomous traveling devices waiting in a background area, the background area being displayed by a mobile terminal carried by the user as a background with respect to the user; search for a target autonomous traveling device whose provision capability matches the required content among the provision capabilities represented by the service capability information for the respective autonomous traveling devices in the background area; display, in a superimposed manner, an extended reality (XR) enhanced image, which highlights the target autonomous traveling device, on a background video showing the background area; and provide the user service by driving, within the background area, the target autonomous traveling device selected by the user in response to superimposed display of the XR enhanced image.

According to a fifth aspect of the present disclosure, a processing method is executed by at least one processor to execute service related processing. The service related processing is related to a user service provided to a user. The processing method includes: acquiring a required content of the user service required by the user; acquiring service capability information representing provision capabilities of the user service, the provision capabilities being associated with autonomous traveling devices waiting in a background area, the background area being displayed by a mobile terminal carried by the user as a background with respect to the user; searching for a target autonomous traveling device whose provision capability matches the required content among the provision capabilities represented by the service capability information for the respective autonomous traveling devices in the background area; displaying, in superimposed manner, an extended reality (XR) enhanced image, which highlights the target autonomous traveling device, on a background video showing the background area; and providing the user service by driving, within the background area, the target autonomous traveling device selected by the user in response to superimposed display of the XR enhanced image.

According to a sixth aspect of the present disclosure, a computer readable non-transitory storage medium stores a program including instructions to execute service related processing. The service related processing is related to a user service provided to a user. The instructions include: acquiring a required content of the user service required by the user; acquiring service capability information representing provision capabilities of the user service, the provision capabilities being associated with autonomous traveling devices waiting in a background area, the background area being displayed by a mobile terminal carried by the user as a background with respect to the user; searching for a target autonomous traveling device whose provision capability matches the required content among the provision capabilities represented by the service capability information for the respective autonomous traveling devices in the background area; displaying, in superimposed manner, an extended reality (XR) enhanced image, which highlights the target autonomous traveling device, on a background video showing the background area; and providing the user service by driving, within the background area, the target autonomous traveling device selected by the user in response to superimposed display of the XR enhanced image.

As described above, according to the fourth to sixth aspects of the present disclosure, the service capability information representing the provision capabilities of the user service, which are associated with the autonomous traveling devices waiting in the background area serving as the display background, is acquired from the mobile terminal carried by the user. Therefore, when the required content of the user service required by the user is acquired, attention is paid to an autonomous traveling device whose provision capability matches the required content among provision capabilities represented by the service capability information for the respective autonomous traveling devices in the background area. Accordingly, the XR enhanced image in which the target autonomous traveling device whose capability matches the required content is highlighted is displayed in a superimposed manner on the background video showing the background area for the selection of the device made by the user. Therefore, it is possible to improve the search efficiency of the autonomous traveling device capable of providing the user service satisfying the user request by being driven in the background area.

Hereinafter, embodiments of the present disclosure will be described with reference to the drawings. It should be noted that the same reference numerals are assigned to corresponding components in the respective embodiments, and overlapping descriptions may be omitted. When only a part of the configuration is described in each embodiment, the configurations of the other embodiments described above can be applied to the other parts of the configuration. Further, not only the combinations of the configurations explicitly specified in the description of each embodiment, but also the configurations of the multiple embodiments can be partially combined even if they are not explicitly specified unless there is a particular problem with the combinations.

### First Embodiment

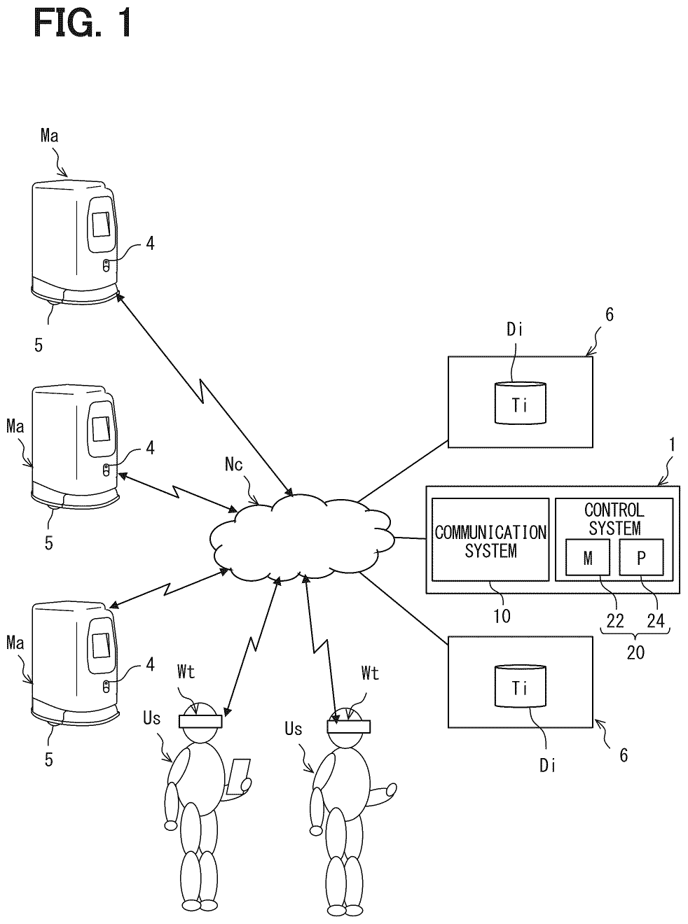

A processing system 1 according to a first embodiment illustrated in FIG. 1 performs service-related processing related to a user service provided to a user Us. To achieve the above purpose, the processing system 1 is connected to a wearable terminal Wt worn by the pre-registered user Us, an autonomous traveling device Ma, and an infrastructure system 6 via a communication network Nc. Multiple wearable terminals Wt and multiple autonomous traveling devices Ma are assumed to be connected to the processing system 1. At least one infrastructure system 6 is assumed to be connected to the processing system 1.

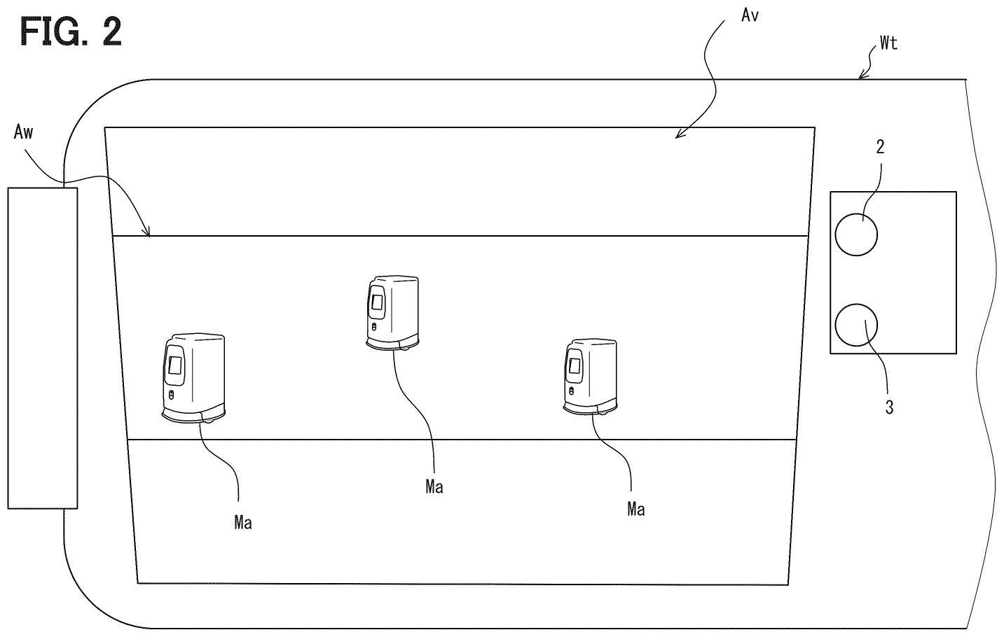

The wearable terminal Wt is designed to be worn on the face of the user Us of the processing system 1 and operable in a hands-free manner at least when being connected to the processing system 1. As illustrated in FIG. 2, the wearable terminal Wt is an optical see-through electronic device including a display unit 2 and a sensor unit 3, and is, for example, a head mounted display (HMD) or smart glasses. Regarding the wearable terminal Wt, FIG. 2 illustrates, in a schematic image drawing, how a visual field area Av is viewed from the user Us side in a portion corresponding to one eye of both eyes of the user Us.

The wearable terminal Wt controls transmission and reception of data via the communication network Nc by a communication unit as illustrated in FIG. 1. The operation of the wearable terminal Wt is controlled by a control unit in accordance with a control command from the processing system 1 via the communication network Nc so that the wearable terminal Wt performs service-related processing in cooperation with the processing system 1.

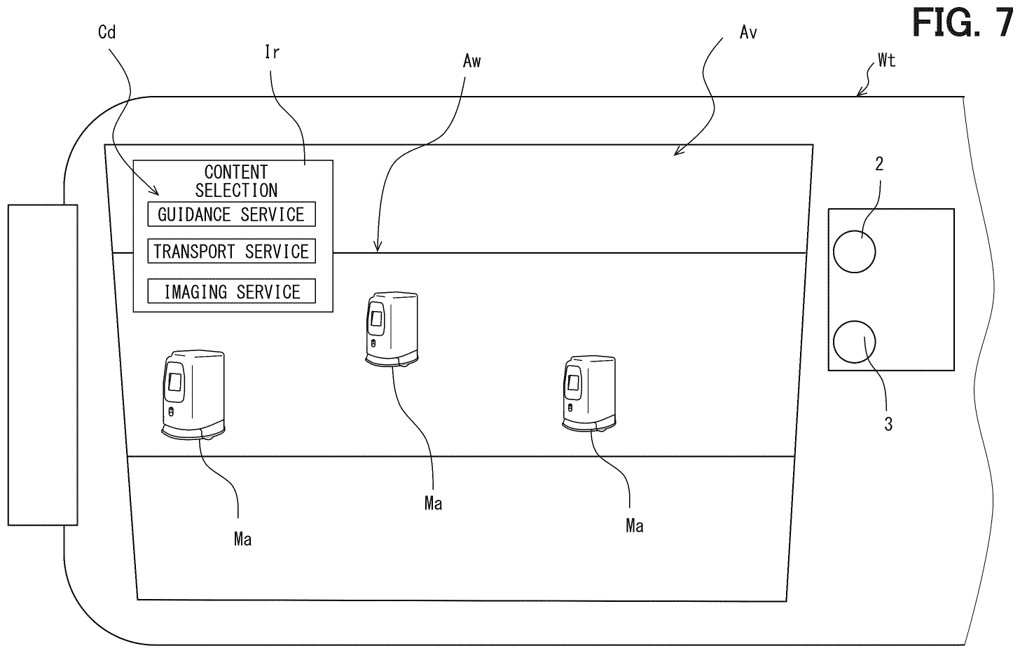

Under the operation control of the control unit of the wearable terminal Wt, the display unit 2 illustrated in FIG. 2, such as a virtual image projection type or a retinal projection type, superimposes a display (see FIGS. 7 to 9 described later) necessary for the service-related processing on a real image of the visual field area Av visually recognized by the user Us through a glass or a lens, and causes the user Us to visually recognize the superimposed display. At the same time, under the operation control of the wearable terminal Wt, the sensor unit 3 illustrated in FIG. 2 acquires sensing information by sensing processing corresponding to the service-related processing. The sensor unit 3 may be at least one of a camera, an inertial sensor, a global navigation satellite system (GNSS) sensor, an electrooculography sensor, a gaze sensor, an infrared sensor, a geomagnetic sensor, a motion sensor, a touch sensor, and a microphone. With such a configuration, the sensor unit 3 can acquire an input representing the intention of the user Us as the sensing information.

The autonomous traveling device Ma illustrated in FIG. 1 is an autonomous traveling vehicle or an autonomous traveling robot capable of autonomously traveling in any direction of front, rear, left, and right by electrically driving wheels 5 based on sensing information acquired by a sensor unit 4. The autonomous traveling device Ma controls transmission and reception of data via the communication network Nc by a communication unit. The autonomous traveling device Ma is driven and controlled by a control unit in accordance with a control command from the processing system 1 via the communication network Nc so that the autonomous traveling device Ma performs service-related processing in cooperation with the processing system 1. Under this drive control, the sensor unit 4 acquires the sensing information by sensing processing corresponding to the service-related processing. The sensor unit 4 may be at least one of a camera, an inertial sensor, a GNSS sensor, a light detection and ranging/laser imaging detection and ranging (LiDAR), and a sonar.

The infrastructure system 6 is a platform system that serves as a common platform for a distributed architecture and shares three-dimensional spatial information Ti stored in an infrastructure database Di. The infrastructure system 6 controls transmission and reception of data via the communication network Nc by a communication unit. The infrastructure system 6 collects, by the control unit at any time, the three-dimensional spatial information Ti to be provided to an individual distributed system such as the processing system 1 constituting the distributed architecture, and updates the stored information of the infrastructure database Di to the latest information.

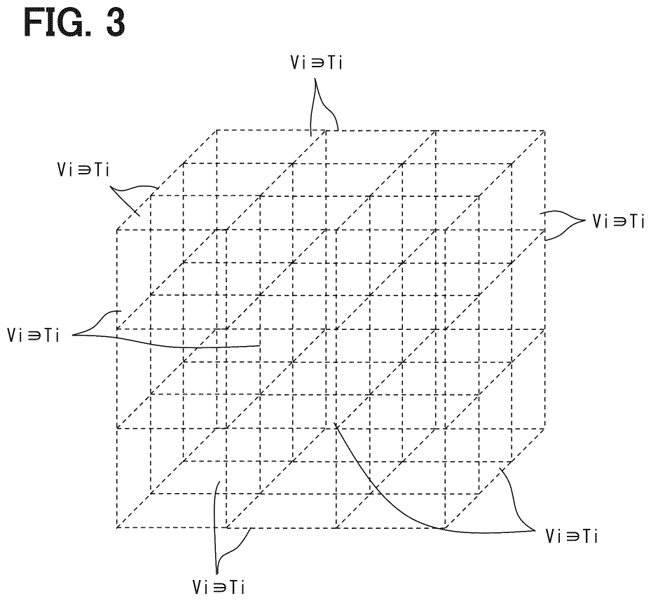

In particular, the infrastructure system 6 manages information by virtually dividing a three-dimensional space in which information is to be stored into multiple three-dimensional voxels Vi (that is, three-dimensional grids) assumed in a three-dimensional array as illustrated in FIG. 3. The infrastructure system 6 stores a data set associated with each space ID individually assigned to each voxel Vi by metadata as the three-dimensional spatial information Ti in the infrastructure database Di as illustrated in FIG. 1. The three-dimensional spatial information Ti may include two-dimensional grid information associated with, for example, only a lower surface of the voxel Vi constituting a lowermost layer of a two-dimensional array along the ground among the three-dimensional array.

The data constructing the three-dimensional spatial information Ti may be collected from at least one of the wearable terminal Wt that cooperates with the processing system 1, other wearable terminals, and a mobile terminal such as a smartphone or a tablet terminal. The data constructing the three-dimensional spatial information Ti may be collected from at least one of the autonomous traveling device Ma that cooperates with the processing system 1 and other moving objects.

The data constructing the three-dimensional spatial information Ti may be collected from at least one of a communication base station, a smart pole, a smart street light, and the like including an infrastructure sensor such as a camera and/or a LIDAR. The data constructing the three-dimensional spatial information Ti may be collected from a servicer that provides at least one of, for example, a map service, a weather service, a communication service, a traffic management service, a feature management service, an aircraft management service, and a user service described later handled by the processing system 1.

The construction data collected in this way to construct the three-dimensional spatial information Ti may be at least one type of image data among, for example, a video, a still image, and a point cloud image. The construction data of the three-dimensional spatial information Ti may be at least one type of secondary data for which information security is ensured among, for example, position data, motion data, posture data, gaze data, action data, and people flow data generated for humans including the user Us of the processing system 1 in a target space for information storage by image processing of such image data, and intention data representing an intention of the user Us described later.

The construction data of the three-dimensional spatial information Ti may be at least one type of secondary data among, for example, position data, motion data, and posture data generated by image processing of image data regarding human belongings including the wearable terminal Wt of the user Us in an information storage target space. The construction data of the three-dimensional spatial information Ti may be at least one type of secondary data among, for example, position data, motion data, and posture data generated by image processing of image data regarding a moving object including the autonomous traveling device Ma in the information storage target space.

The construction data of the three-dimensional spatial information Ti may be speech data obtained by collecting speeches of humans including the user Us of the processing system 1 in the information storage target space. The construction data of the three-dimensional spatial information Ti may be at least one type of secondary data for which information security is ensured among, for example, position data, motion data, action data, people flow data, conversation data, which are analyzed with respect to humans including the user Us by speech recognition processing of such speech data, and intention data representing an intention of the user Us to be described later.

The construction data of the three-dimensional spatial information Ti may be, for example, at least one type of two-dimensional and/or three-dimensional map data, geographic information system (GIS) data, road network data, weather data, communication data, line data, traffic data, feature management data, building information modeling (BIM) data, point of interest (POI) data, air management data, and time data. The construction data of the three-dimensional spatial information Ti may be service data related to at least one of, for example, a guidance service, a transport service, and an imaging service, which will be described later as the user service handled by the processing system 1. The imaging service is also known as photo shooting service.

As illustrated in FIG. 1, the processing system 1 is a distributed computer system including a communication system 10 and a control system 20, and constructed to include at least one of, for example, a cloud server and an edge server. At least a portion of the communication system 10 and at least a portion of the control system 20 in the processing system 1 may include the communication unit and the control unit of the wearable terminal Wt, respectively. At least a portion of the communication system 10 and at least a portion of the control system 20 in the processing system 1 may include the communication unit and the control unit of the autonomous traveling device Ma, respectively. At least a portion of the communication system 10 and at least a portion of the control system 20 in the processing system 1 may include the communication unit and the control unit of the infrastructure system 6, respectively.

The communication system 10 mainly includes a communication device for constructing the communication network Nc. The control system 20 is connected to the communication system 10 via at least one of a wired communication line and a wireless communication line. The control system 20 includes at least one dedicated computer. The dedicated computer constituting the control system 20 includes at least one memory 22 and at least one processor 24.

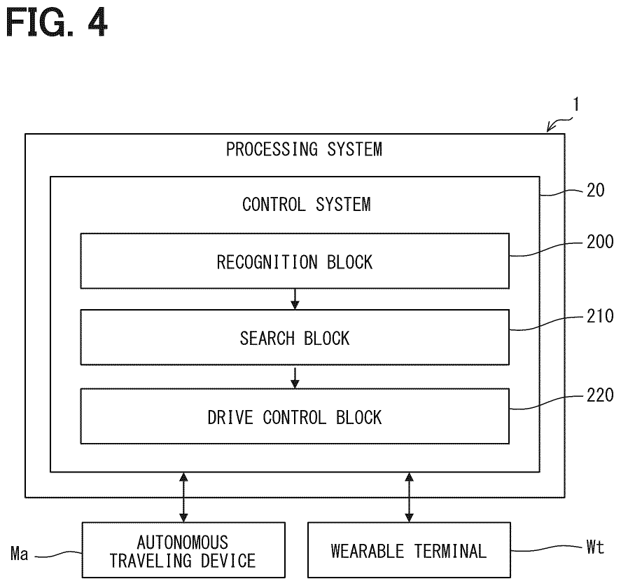

In the processing system 1, the control system 20 causes the processor 24 to execute multiple instructions of a processing program stored in the memory 22. As a result, the control system 20 constructs multiple functional blocks for performing the service-related processing related to the user service provided to the user Us. As illustrated in FIG. 4, the constructed functional blocks include a recognition block 200, a search block 210, and a drive control block 220.

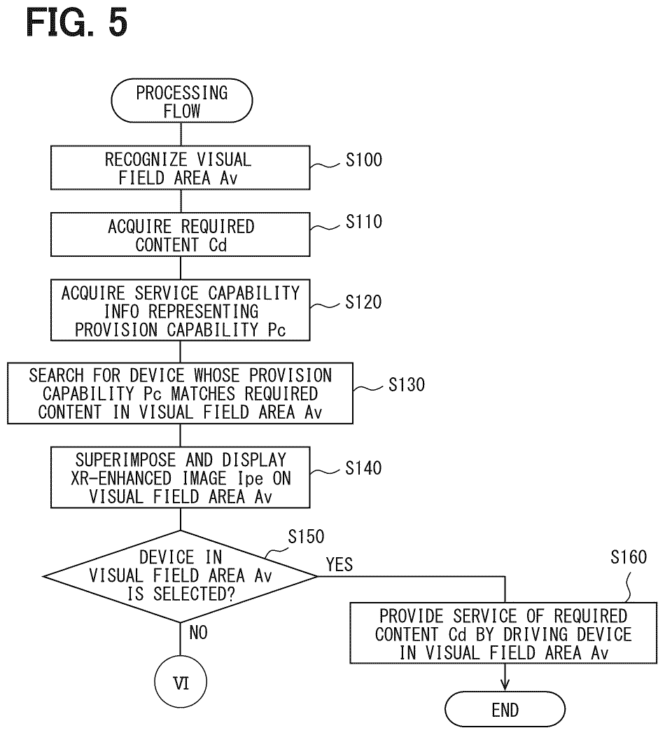

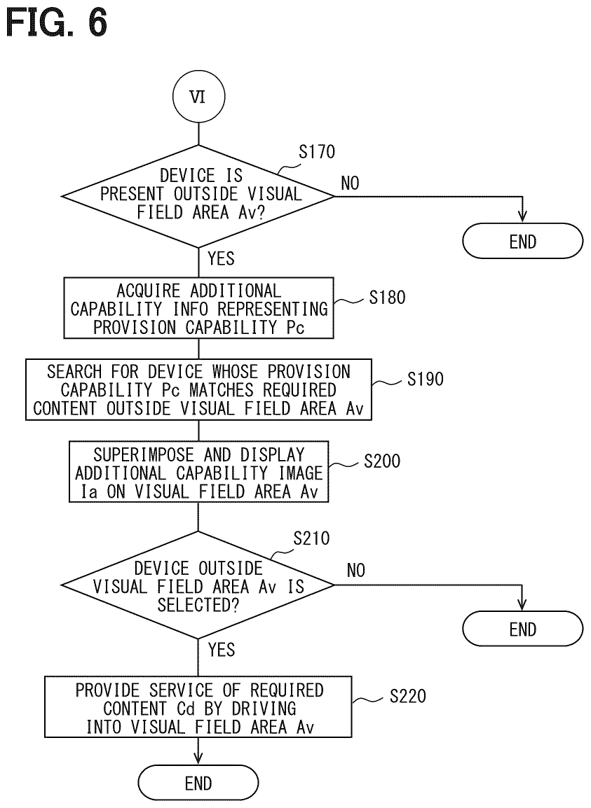

A processing method in which the processing system 1 performs the service-related processing by cooperation of these blocks 200, 210, and 220 is executed according to the processing flow illustrated in FIGS. 5 and 6. This processing flow is executed in response to the sensor unit 3 of the wearable terminal Wt acquiring a service request input intended by the user Us to request provision of a user service as the sensing information. Each “S” in this processing flow means multiple steps executed by multiple instructions included in the processing program of the first embodiment.

In S100 of the processing flow, the recognition block 200 (see FIG. 4) recognizes the visual field area Av to be visually recognized by the user Us through the wearable terminal Wt. At this time, the visual field area Av is recognized in a manner of overlapping a waiting area Aw in which the multiple autonomous traveling devices Ma can wait as illustrated in FIG. 2 at, for example, a station, a terminal, a facility entrance, or a landmark in the information storage target space of the infrastructure system 6.

In S100, when there is no autonomous traveling device Ma present in the waiting area Aw overlapping the visual field area Av, the current execution of the processing flow ends. In this case, an XR notification image may be superimposed and displayed in the visual field area Av to notify an unsuccessful search result due to the absence of the available autonomous traveling device Ma. In the present disclosure, XR indicates extended reality. As well known, XR includes virtual reality (VR), augmented reality (AR), and mixed reality (MR).

The recognition processing of the visual field area Av in S100 is based on at least one type of sensing information such as camera information and inertial information acquired by the sensor unit 3 of the wearable terminal Wt. As a result, the visual field area Av is recognized as an area extending in a direction in which the face or gaze of the user Us faces or a direction in which the wearable terminal Wt faces.

In S110 illustrated in FIG. 5, the recognition block 200 acquires a required content Cd (see FIG. 7) of the user service required by the user Us. At this time, the required content Cd is recognized based on sensing information about the face of the user Us acquired by the wearable terminal Wt worn on the face. The sensing information for recognizing the required content Cd is acquired through the wearable terminal Wt at a timing when the sensing information is input to the sensor unit 3 as the intention data of the user Us.

As the input of the required content Cd in S110, gesture input, gaze input, facial expression input, or speech input by the user Us may be sensed by the sensor unit 3. At this time, in the display unit 2 of the wearable terminal Wt, an XR reception image Ir for receiving the input of the required content Cd from the user Us by the sensor unit 3 may be superimposed and displayed on the visual field area Av as illustrated in FIG. 7. The required content Cd may be recognized based on the three-dimensional spatial information Ti obtained from the infrastructure database Di through the communication system 10.

The item of the required content Cd recognized in S110 includes at least the type of user service that can be provided to the user Us of the processing system 1 as illustrated in FIG. 7. As the type of the user service corresponding to the required content Cd, for example, at least one of the guidance service, the transport service, and the imaging service is prepared.

In S110, regardless of the type of service of the recognized required content Cd, the content Cd may include at least one type of speech-related item, such as necessity of speech output, necessity of speech recognition function, and necessity of an interactive function. When the type of the required content Cd is either the guidance service or the transport service, the content Cd may include at least one of route-related item, such as a route including a destination, a movement pace, an arrival time, and a service provision time (that is, a guidance time or a transport time).

When the type of the required content Cd is the guidance service, the content Cd may include at least one type of tourism-related item, such as an allowable congestion degree, presence or absence of a required facility, and presence or absence of nature, for a destination such as a tourist spot. When the type of the required content Cd is the guidance service, the content Cd may include an option item representing a requirement to use another type of service together as an option function.

In the required content Cd, the option item representing the requirement to use the transport service as the transport function in the guidance service may include at least one type of package-related item, such as the number, size, weight, type, and necessity of temperature management of packages. This also applies to a case of a transport service independent of the guidance service.

In the required content Cd, the option item representing the requirement to use the imaging service as the imaging function in the guidance service may include at least one type of imaging-related item, such as an imaging schedule, an imaging timing, an imaging position, necessity of transmission of an image or data, and necessity of printing a photograph. The same applies to a case of an imaging service independent of the guidance service.

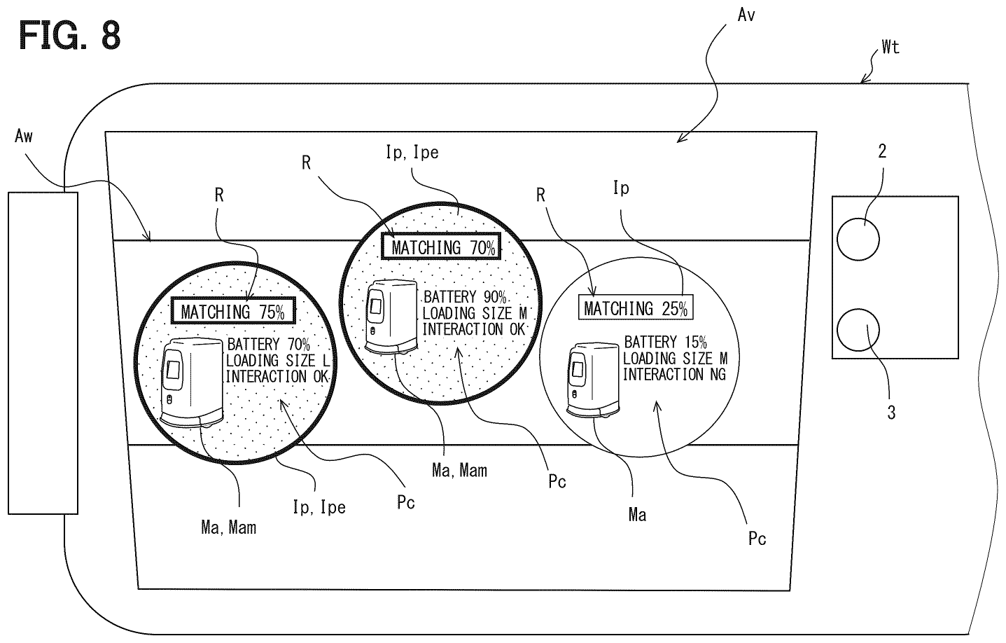

In S120 illustrated in FIG. 5, the search block 210 (see FIG. 4) acquires service capability information representing provision capabilities Pc (see FIG. 8) of the user service, which are associated with the autonomous traveling devices Ma waiting in the waiting area Aw in the visual field area Av recognized in S100. At this time, the service capability information may be information capable of identifying holding capabilities of the respective autonomous traveling devices Ma waiting in the waiting area Aw in the visual field area Av as the provision capabilities Pc necessary for providing the user service of the type prepared in the processing system 1.

The provision capability Pc for various services may include at least one type of traveling-related capability, such as a remaining battery level, a drivable distance, a maximum travelable speed, a minimum travelable road width, a travelable road surface state, and an obstacle avoidance level according to a congestion degree. The provision capability Pc for various services may include at least one type of speech-related capability, such as availability of speech output, presence or absence of a speech recognition function, and presence or absence of an interactive function.

The provision capability Pc for the transport service provided as the transport function in the guidance service may include at least one type of transport-related capability, such as presence or absence of a loading chamber, a loadable size, a loadable total package weight, a loadable package type, presence or absence of a refrigeration function, and presence or absence of a freezing function. The same applies to a case of the provision capability Pc for a transport service independent of the guidance service.

The provision capability Pc for the imaging service provided as the imaging function in the guidance service may include at least one type of imaging-related capability, such as presence or absence of a camera function, presence or absence of an image or video data transmission function, and presence or absence of a photograph print function. The same applies to a case of the provision capability Pc for a reflection service independent of the guidance service.

In S120, the service capability information regarding the provision capability Pc may be acquired through the communication system 10 from the communication unit of the autonomous traveling device Ma waiting in the waiting area Aw in the visual field area Av. The service capability information may be acquired based on the three-dimensional spatial information Ti obtained from the infrastructure database Di through the communication system 10. The service capability information may be acquired by the sensor unit 3 such as a camera in the wearable terminal Wt capturing an image of a QR code (registered trademark) displayed on the display unit of the autonomous traveling device Ma waiting in the waiting area Aw in the visual field area Av.

In S130 illustrated in FIG. 5, the search block 210 searches for the autonomous traveling device Ma whose provision capability Pc matches the required content Cd acquired in S110 among the provision capabilities Pc represented by the service capability information acquired for the respective autonomous traveling devices Ma in the visual field area Av in S120. At this time, a matching degree R (see FIG. 8) of the provision capability Pc with respect to the required content Cd is acquired.

In S130, the matching degree R is acquired as an index correlated with a relevance rate scored for each item other than the type included in the required content Cd with respect to the provision capability Pc for providing the user service of the type represented by the required content Cd. For example, as illustrated in the following numerical formula 1, the matching degree R may be acquired by normalizing an integrated value of a relevance rate ri scored for each item of an index i by an integrated value of a maximum relevance rate rmi of each item. The matching degree R may be acquired by standardizing the integrated value of the relevance rate ri for each item, or may be acquired by inputting the relevance rate ri for each item to a machine learning model.

$$R = \frac{\sum {r}_{i}}{\sum {rm}_{i}} \qquad ( Numerical Formula 1 )$$

In S130, the autonomous traveling device Ma whose matching degree R acquired in this way is within a recommended range is extracted as a search result of a matching device Mam having the provision capability Pc matched with the required content Cd. The recommended range at this time is defined as a range in which the relevance rate is equal to or greater than a threshold or exceeds the threshold and equal to or less than a maximum value so that the matching degree R with respect to the required content Cd is within a range that can be recommended to the user Us. The threshold for determining a lower limit of the recommended range may be set to, for example, a specific value of 50% to 80% (when the maximum value is normalized to 100%) or a specific value of 0.5 to 0.8 (when the maximum value is normalized to 1) when the matching degree R is acquired by the normalization described above.

In S140 illustrated in FIG. 5, the search block 210 causes the display unit 2 of the wearable terminal Wt to superimpose and display XR-enhanced images Ipe which highlights the matching devices Mam found in S130 as illustrated in FIG. 8 on the visual field area Av. Therefore, in S140, among the provision capabilities Pc represented by the service capability information acquired for the respective autonomous traveling devices Ma in S120, the provision capability Pc for the user service corresponding to the required content Cd acquired in S110 is extracted.

In S140, as illustrated in FIG. 8, XR capability images Ip, which are candidates for the XR-enhanced images Ipe, are superimposed and displayed on the visual field area Av by the display unit 2 to notify the provision capabilities Pc of the respective autonomous traveling devices Ma for the user service corresponding to the required content Cd. In particular, the XR capability image Ip is superimposed and displayed while being aligned with the corresponding autonomous traveling device Ma in the visual field area Av to notify the matching degree R acquired in S130 together with the provision capability Pc. Therefore, a superimposed display position of the XR capability image Ip is adjusted to be visually recognized at a surrounding position of the autonomous traveling device Ma based on, for example, the sensing information acquired by at least one of the sensor units 3 and 4 and/or the three-dimensional spatial information Ti obtained from the infrastructure database Di. At this time, the visual field area Av on which the XR capability image Ip is superimposed and displayed may be fixed to the area recognized in S100 or may be updated in accordance with S100 by the viewpoint movement of the user Us.

In S140, among the XR capability images Ip superimposed and displayed in the visual field area Av, the corresponding XR capability images Ip in which the matching device Mam whose matching degree R of the provision capability Pc with respect to the required content Cd is within the recommended range is highlighted is set as the XR-enhanced image Ipe. Therefore, the XR capability image Ip set as the XR-enhanced image Ipe is highlighted by at least one of differences in color, size, line width, and the like regarding character display and/or background window display with respect to the XR capability image Ip that is not set as the XR-enhanced image Ipe.

In such S140, when fewer matching devices Mam than the autonomous traveling devices Ma present within the visual field area Av are found in S130, both the XR capability image Ip that is set as the XR-enhanced image Ipe and the XR capability image Ip that is not set as the XR-enhanced image Ipe are superimposed and displayed. Meanwhile, in S140, when the same number of matching devices Mam as the number of autonomous traveling devices Ma present in the visual field area Av are found in S130, only the XR capability image Ip set as the XR-enhanced image Ipe is superimposed and displayed. Further, in S140, when no matching device Mam is found in S130, only the XR capability image Ip that is not set as the XR-enhanced image Ipe is superimposed and displayed.

In S150 illustrated in FIG. 5, the search block 210 determines whether any autonomous traveling device Ma in the visual field area Av is selected by the user Us in response to the superimposed display in S140. At this time, the presence or absence of the selection made by the user Us is recognized based on the sensing information regarding the face acquired by the wearable terminal Wt. Therefore, the sensing information for recognizing the presence or absence of selection made by the user Us is input into the sensor unit 3 as the intention data of the user Us and is acquired through the wearable terminal Wt.

As the selection input of the autonomous traveling device Ma in S150, the gesture input, the gaze input, the facial expression input, or the speech input made by the user Us may be sensed by the sensor unit 3. The selection input at this time may be an input for selecting an existence position of the autonomous traveling device Ma or an input for selecting the images Ip and Ipe corresponding to the autonomous traveling device Ma. For any selection input, the selection position may be recognized based on, for example, the sensing information acquired by at least one of the sensor units 3 and 4 and/or the three-dimensional spatial information Ti obtained from the infrastructure database Di. The recognition of the presence or absence of the selection made by the user Us and the selection position may be implemented based on the three-dimensional spatial information Ti obtained from the infrastructure database Di through the communication system 10.

When an affirmative determination is made by recognizing the selection made by the user Us in S150, S160 is executed as illustrated in FIG. 5. In S160, the drive control block 220 (see FIG. 4) provides a user service of a type corresponding to the required content Cd by controlling the drive of the autonomous traveling device Ma selected in S150 in the visual field area Av. At this time, the user service is provided according to a drive control pattern by reading the drive control pattern of the autonomous traveling device Ma according to the required content Cd from the memory 22.

In S160, the guidance service is provided through a drive control pattern in which the autonomous traveling device Ma is driven from a waiting position to a current position of a guidance target such as the user Us or a registered family to execute route guidance to leading the guidance target to a destination, and then returns to the waiting area Aw. At this time, in the guidance service, a route for guiding the guidance target may be presented by superimposing and displaying an XR presentation image on the visual field area Av in the wearable terminal Wt or by display output from the display unit held by the autonomous traveling device Ma. In the guidance service, the route for guiding the guidance target may be presented by speech output from a speech unit held by the wearable terminal Wt or the autonomous traveling device Ma.

In S160, the transport service is provided through a drive control pattern in which the autonomous traveling device Ma holding a loading chamber is driven from a waiting position to a current position of the user Us, receives loading of a package into the loading chamber from the user Us, transports the package to a destination, and then returns to the waiting area Aw. At this time, in the transport service, a method of loading the package into the loading chamber may be presented to the user Us by superimposing and displaying the XR presentation image on the visual field area Av in the wearable terminal Wt or by the display output from the display unit of the autonomous traveling device Ma. In the transport service, the loading of package into the loading chamber may be presented to the user Us by the speech output from the speech unit held by the wearable terminal Wt or the autonomous traveling device Ma. Such a transport service may be provided as a transport function of the guidance service when the transport service is included in the required content Cd.

In S160, the imaging service is provided by a drive control pattern in which the autonomous traveling device Ma holding an imaging unit is driven from a waiting position to a current position of the user Us or to a landmark around the user Us to capture an image of the user Us from the surroundings and then returns to the waiting area Aw. At this time, in the imaging service, the imaging schedule or the imaging timing may be presented to the user Us by superimposing and displaying the XR presentation image on the visual field area Av in the wearable terminal Wt or by the display output from the display unit of the autonomous traveling device Ma. In the imaging service, the imaging schedule or the imaging timing may be presented to the user Us by the speech output from the speech unit held by the wearable terminal Wt or the autonomous traveling device Ma.

In the imaging service provided in S160, a two-dimensional or three-dimensional still image or video may be captured to include the user Us by the autonomous traveling device Ma driven around the user Us. In the imaging service, the focus at the time of imaging may be adjusted based on a distance to the user Us sensed by the sensor unit 4 such as a LiDAR in the autonomous traveling device Ma.

In the imaging service provided in S160, an external light incident direction at the time of imaging may be adjusted based on the three-dimensional spatial information Ti obtained from the infrastructure database Di or sensing information from the sensor unit 4 such as a camera in the autonomous traveling device Ma. In the imaging service, image data obtained by imaging the user Us may be stored in the memory 22 of the control system 20 or a storage medium in the wearable terminal Wt. The imaging service described above may be provided as an imaging function of the guidance service when the imaging service is included in the required content Cd.

The viewpoint of the user Us moves as needed in accordance with the progress of the user service by such drive control of the autonomous traveling device Ma. Therefore, in S160, the visual field area Av is updated in accordance with S100, so that the autonomous traveling device Ma that provides the user service may be driven at any time in the updated visual field area Av.

In S150 described above, a negative determination is made, for example, when the user Us does not execute the selection input during a period from the start of the execution to the elapse of the set time, or when the user Us inputs an intention that there is no autonomous traveling device Ma required to be selected. In this case, in response to determining that the selection made by the user Us for the autonomous traveling device Ma in the visual field area Av is rejected, S170 is executed as illustrated in FIGS. 5 and 6.

In S170 illustrated in FIG. 6, the search block 210 determines whether there is an autonomous traveling device Ma waiting within a set distance from the user Us outside the recognized visual field area Av. At this time, the presence or absence of the autonomous traveling device Ma within the set distance outside the visual field area Av may be recognized based on the three-dimensional spatial information Ti obtained from the infrastructure database Di through the communication system 10.

When an affirmative determination is made in S170, S180 is executed as illustrated in FIG. 6. In S180, the search block 210 acquires, as additional capability information, service capability information representing the provision capabilities Pc of the user service, which are associated with the autonomous traveling devices Ma whose presence is recognized in S170 and which are waiting outside the visual field area Av. At this time, the additional capability information is acquired in accordance with S120.

In S190 illustrated in FIG. 6, the search block 210 searches for the matching devices Mam whose provision capabilities Pc represented by the additional capability information acquired for the respective autonomous traveling devices Ma outside the visual field area Av in S180 match the required content Cd acquired in S110. The searching at this time is also implemented based on the matching degree R acquired in accordance with S130.

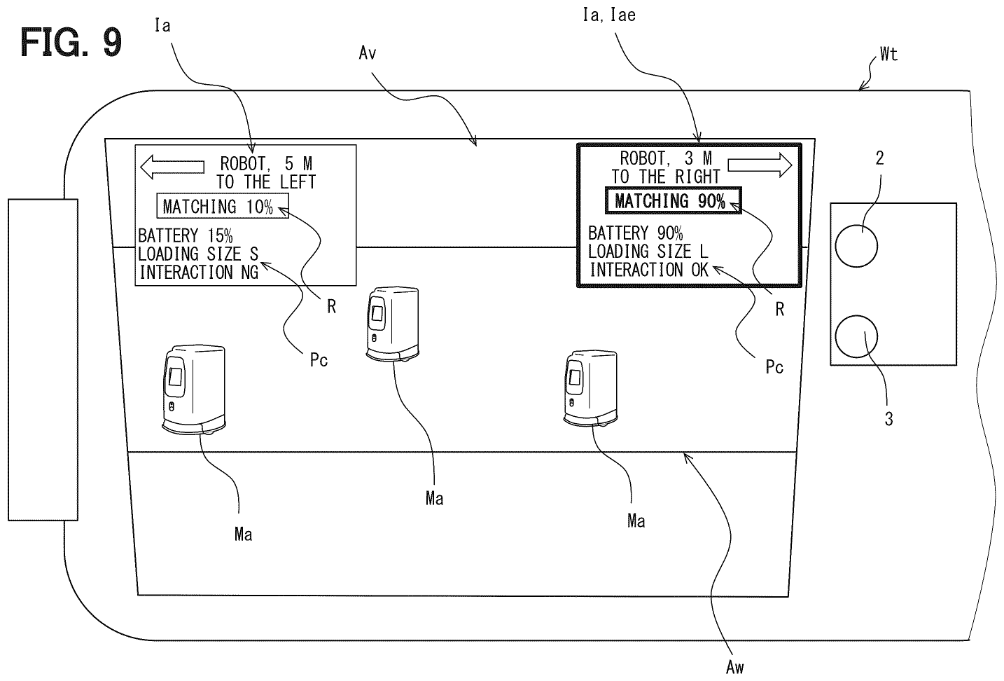

In S200 illustrated in FIG. 6, the search block 210 notifies the provision capabilities Pc represented by the additional capability information acquired for the respective autonomous traveling device Ma outside the visual field area Av in S180. In S200, the display unit 2 of the wearable terminal Wt superimposes and displays an additional capability image Ia illustrated in FIG. 9 on the visual field area Av to implement such a notification in accordance with the XR capability image Ip.

In S200, particularly, the additional capability image Ia is superimposed and displayed on, for example, an aerial area or a ground area in the visual field area Av to notify the matching degree R acquired in S190 together with the provision capability Pc. The additional capability image Ia may notify at least one of a direction from the user Us, a distance from the user Us, and an arrival time to the user Us by calling, for example, regarding the existence position of the corresponding autonomous traveling device Ma. The additional capability image Ia may be set as an additional enhanced image Iae that highlights the matching device Mam found in S190 (in the example of FIG. 9, the autonomous traveling device Ma for which the existence position is displayed as “robot, 3 meters to the right”) in accordance with the XR-enhanced image Ipe. The additional capability image Ia may be superimposed and displayed at a fixed relative position with respect to a glass or a lens of the display unit 2 in the visual field area Av, or may be superimposed and displayed as the XR capability image Ip (including the XR-enhanced image Ipe for the matching device Mam) at a fixed relative position with respect to the autonomous traveling device Ma in the visual field area Av. In any of these cases, the visual field area Av on which the additional capability image la is superimposed and displayed may be fixed to the area recognized in S100 or may be updated in accordance with S100 by the viewpoint movement of the user Us.

In S210 illustrated in FIG. 6, the search block 210 determines, in accordance with S150, whether any autonomous traveling device Ma outside the visual field area Av is selected by the user Us in response to the superimposed display in S200. As a result, when an affirmative determination is made by recognizing the selection made by the user Us, S220 is executed. In S220, the drive control block 220 performs control to drive the autonomous traveling device Ma selected in S210 into the visual field area Av in order to provide a user service corresponding to the required content Cd in accordance with S160. In other words, in S220, the service of the required content Cd can be provided by controlling the driving of the selected autonomous traveling device Ma into the visual field area Av.

In the processing flow illustrated in FIGS. 5 and 6 described above, when the provision of the user service corresponding to the required content Cd is completed by either S160 or S220, the current execution ends. Meanwhile, when a negative determination is made in any one of S170 and S210, the current execution of the processing flow may be completed after the XR notification image notifying an unsuccessful search result is superimposed and displayed on the visual field area Av. In either case, after the current execution is completed, the next execution of the processing flow is started by acquiring the next service request input through the sensor unit 3 of the wearable terminal Wt.

### (Effects)

The effects of the first embodiment described above will be described below.

According to the first embodiment, the service capability information representing the provision capabilities Pc of the user service, which are associated with the autonomous traveling devices Ma waiting in the visual field area Av to be visually recognized by the user Us, is acquired through the wearable terminal Wt worn by the user Us. Therefore, when the required content Cd of the user service required by the user Us is acquired, attention is paid to the autonomous traveling device Ma whose provision capability Pc matches the required content Cd among provision capabilities Pc represented by the service capability information for the respective autonomous traveling devices Ma in the visual field area Av. Accordingly, the XR-enhanced image Ipe in which the found autonomous traveling device Ma (specifically, the matching device Mam) whose capability Pc matches the required content Cd is highlighted is superimposed and displayed in the visual field area Av for the selection of the device Ma made by the user Us. Therefore, it is possible to improve the search efficiency of the autonomous traveling device Ma capable of providing the user service satisfying the user request by being driven in the visual field area Av.

Further, according to the first embodiment, the XR capability images Ip are superimposed and displayed on the visual field area Av while being aligned with the respective autonomous traveling devices Ma to notify the provision capabilities Pc corresponding to the required content Cd for the respective autonomous traveling devices Ma in the visual field area Av. Therefore, among the XR capability images Ip of the respective autonomous traveling devices Ma, the XR capability image Ip, which highlights the corresponding autonomous traveling device Ma (specifically, the matching device Mam) whose matching degree R of the provision capability Pc with respect to the required content Cd is within the recommended range, is set as the XR-enhanced image Ipe. Accordingly, among the autonomous traveling devices Ma in the visual field area Av whose provision capabilities Pc are notified, the user Us can appropriately select the autonomous traveling device Ma automatically found based on the matching degree R between the required content Cd and the provision capability Pc, for example, without making a reservation in advance. Therefore, not only the search efficiency of the autonomous traveling device Ma capable of providing the user service satisfying the user request but also the search accuracy can be improved by reducing the gap between the required content Cd and the provision capability Pc.

According to the first embodiment, the XR capability image Ip is superimposed and displayed on the visual field area Av to notify the matching degree R together with the provision capability Pc. Accordingly, the user Us can intuitively select the autonomous traveling device Ma highlighted together with the notification of the matching degree of the provision capability Pc with respect to the required content Cd among the autonomous traveling devices Ma whose provision capabilities Pc are notified in the visual field area Av. Therefore, reliability can be given to the high-efficiency search of the autonomous traveling device Ma capable of providing the user service satisfying the user request.

Further, according to the first embodiment, in response to determining that the selection made by the user Us from among the autonomous traveling devices Ma in the visual field area Av is rejected, the service capability information of the autonomous traveling device Ma waiting outside the visual field area Av is acquired as the additional capability information. Therefore, the additional capability image Ia notifying the provision capability Pc represented by the additional capability information is superimposed and displayed on the visual field area Av. According to this, even when the autonomous traveling device Ma capable of providing the user service satisfying the user request is not found in the visual field area Av, the search result of the device Ma expanded outside the visual field area Av can be notified to the user Us. Therefore, it is possible to secure the fail-safe property in the high-efficiency search of the autonomous traveling device Ma and to give the user Us a sense of security.

Moreover, according to the first embodiment, the autonomous traveling device Ma selected by the user Us in response to the superimposed display of the additional capability image Ia is driven into the visual field area Av to provide the user service. As a result, the user Us selects the autonomous traveling device Ma notified by the high-efficiency search outside the visual field area Av, so that a user service satisfying the preference of the user Us can be provided by the device Ma automatically called into the visual field area Av.

### Second Embodiment

A second embodiment is a modification of the first embodiment.

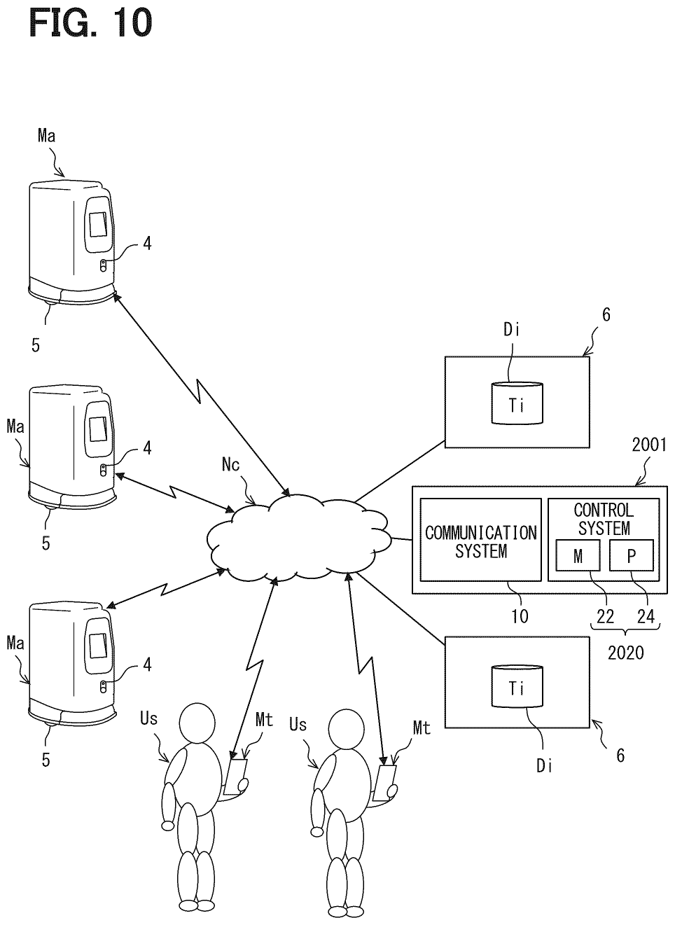

As illustrated in FIG. 10, a processing system 2001 according to the second embodiment is connected to a mobile terminal Mt carried by the pre-registered user Us, the autonomous traveling device Ma that autonomously travels, and the infrastructure system 6 that provides infrastructure information, via the communication network Nc. It is assumed that multiple the mobile terminals Mt are connected to the processing system 2001.

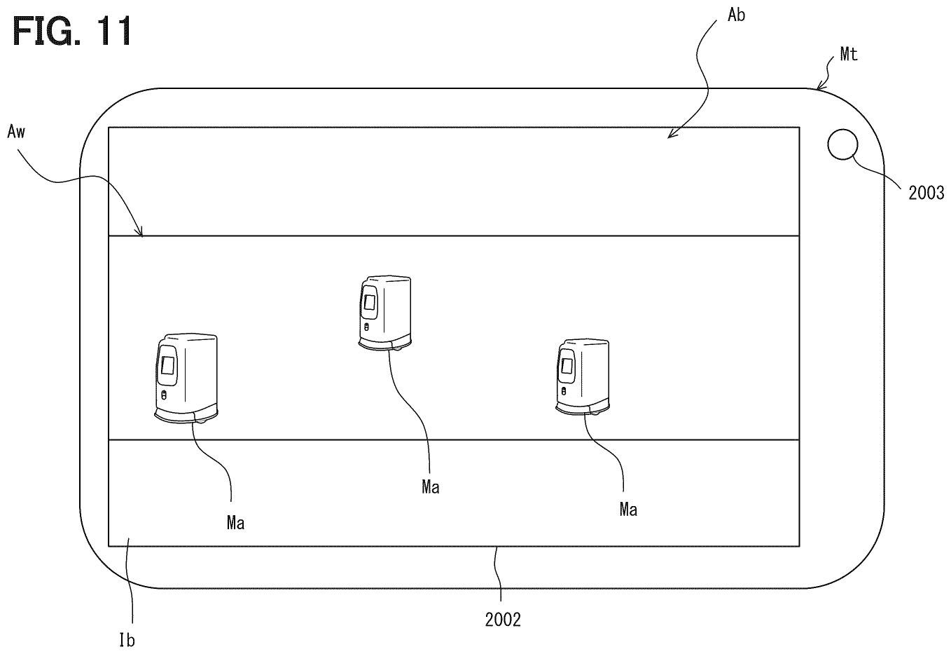

The mobile terminal Mt is designed such that the user Us of the processing system 2001 can hold and operate the mobile terminal Mt with fingers at least when being connected to the processing system 2001. As illustrated in FIG. 11, the mobile terminal Mt is a small electronic device including a display unit 2002 and a sensor unit 2003, and is, for example, a smartphone or a tablet terminal. The mobile terminal Mt controls transmission and reception of data via the communication network Nc by a communication unit as illustrated in FIG. 10. The operation of the mobile terminal Mt is controlled by a control unit in accordance with a control command from the processing system 2001 via the communication network Nc so that the mobile terminal Mt performs service-related processing in cooperation with the processing system 2001.

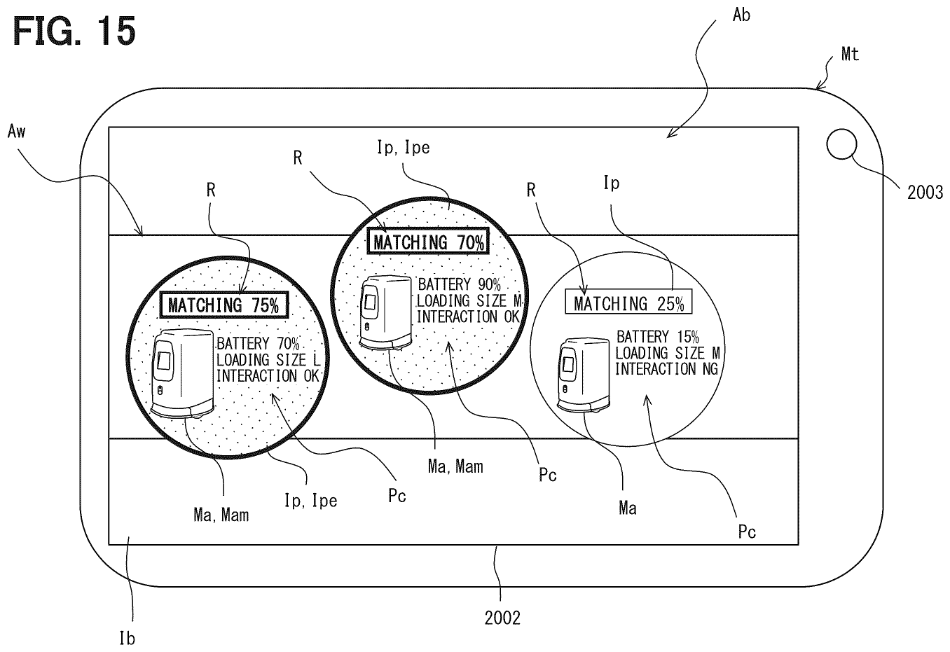

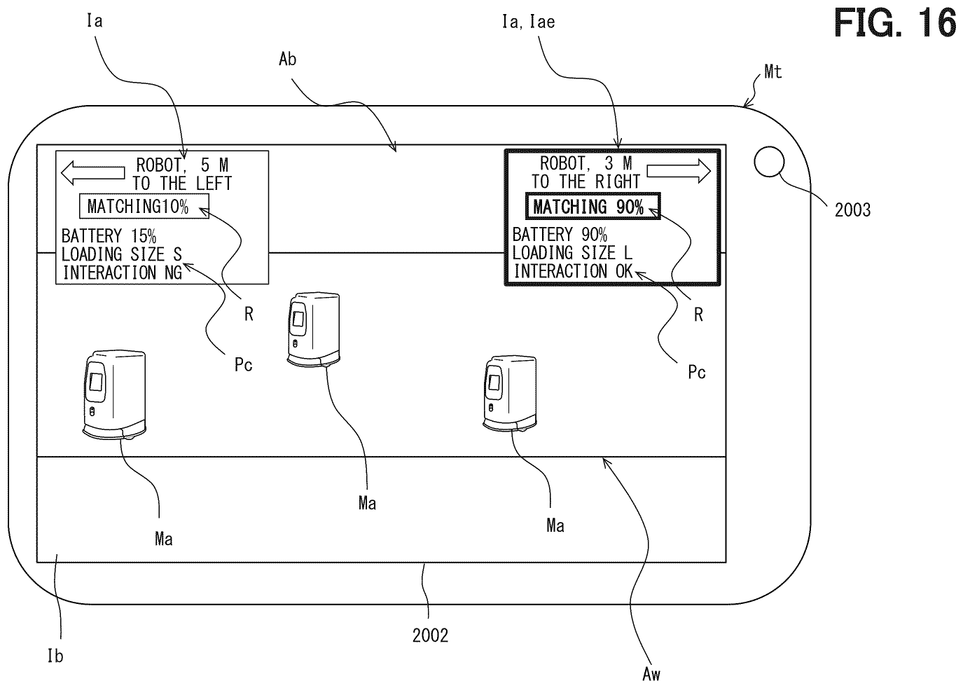

Under the operation control by the control unit of the mobile terminal Mt, the display unit 2002 illustrated in FIG. 11 such as a liquid crystal panel or an organic EL panel implements screen display (see FIGS. 15 and 16 described later) necessary for the service-related processing. At the same time, under the operation control of the mobile terminal Mt, the sensor unit 2003 illustrated in FIG. 11 acquires sensing information by sensing processing corresponding to the service-related processing. As the sensor unit 2003, for example, at least one of a camera, an inertial sensor, a GNSS sensor, a touch sensor, and a microphone is adopted. With such a configuration, the sensor unit 2003 can acquire an input representing an intention of the user Us as the sensing information.

The autonomous traveling device Ma illustrated in FIG. 10 is implemented in the same manner as the processing system 1 according to the first embodiment except that the autonomous traveling device Ma is driven and controlled by the control unit in accordance with the control command from the processing system 2001 via the communication network Nc to execute the service-related processing in cooperation with the processing system 2001. A control system 2020 of the processing system 2001 is implemented in the same manner as the control system 20 according to the first embodiment except that at least a part of the control system 2020 may be implemented by the control unit of the mobile terminal Mt and that the control system 2020 executes a processing flow using the mobile terminal Mt, which is to be described later.

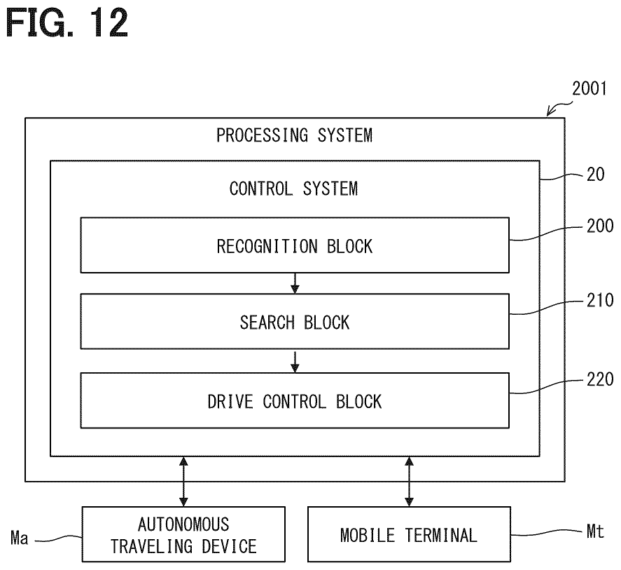

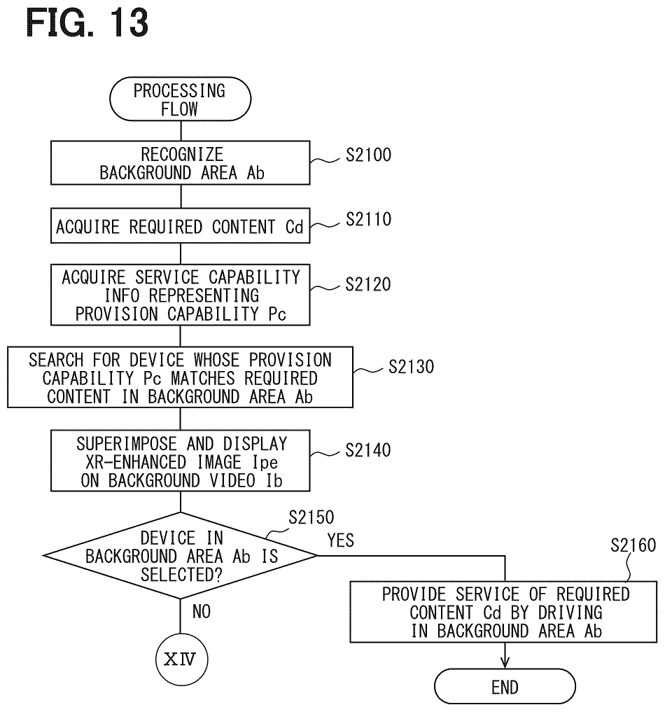

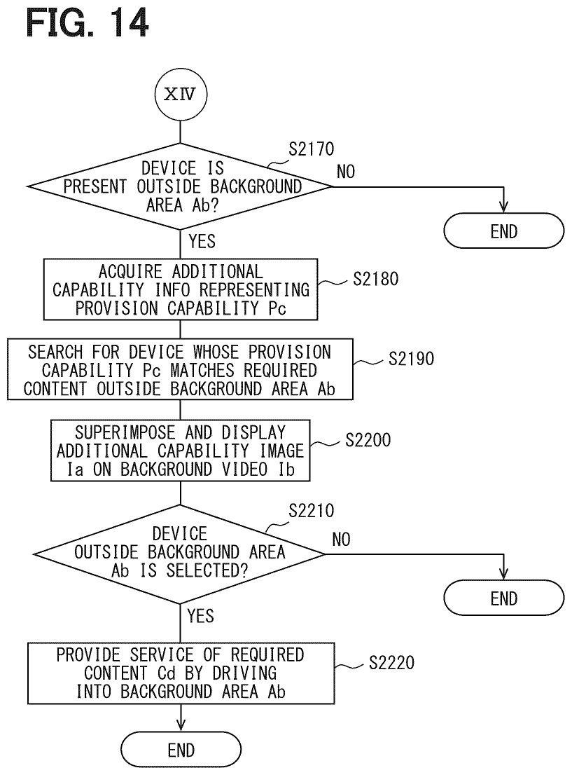

In order to perform the service-related processing in the control system 2020, a processing method in which the processing system 2001 performs the service-related processing by cooperation of the blocks 200, 210, and 220 constructed as illustrated in FIG. 12 is executed according to a processing flow illustrated in FIGS. 13 and 14.

In S2100 of the processing flow, the recognition block 200 (see FIG. 12) recognizes a background area Ab serving as a display background from the display unit 2002 to the user Us by directing the mobile terminal Mt carried by the user Us. At this time, the background area Ab is recognized as an area Ab extending in a direction in which the mobile terminal Mt faces based on at least one type of sensing information such as camera information and inertial information acquired by the sensor unit 2003 of the mobile terminal Mt. In particular, the background area Ab may be recognized in a manner of overlapping the waiting area Aw in which multiple autonomous traveling devices Ma can wait as illustrated in FIG. 11 in accordance with the visual field area Av recognized in S100 in the first embodiment. When there is no autonomous traveling device Ma present in the waiting area Aw overlapping the background area Ab, processing is similar to that in S100 of the first embodiment.

In S2110 illustrated in FIG. 13, the recognition block 200 acquires the required content Cd required by the user Us based on the sensing information acquired by the mobile terminal Mt carried by the user Us. The sensing information at this time is used to recognize the required content Cd by being acquired through the mobile terminal Mt at a timing at which the sensing information is input to the sensor unit 2003 as intention data of the user Us. The items of the required content Cd and the input thereof are similar to those in S110 in the first embodiment.

In S2120 illustrated in FIG. 13, the search block 210 (see FIG. 12) acquires service capability information representing the provision capabilities Pc (see FIG. 15) of the user service, which are associated with the autonomous traveling devices Ma waiting in the waiting area Aw in the background area Ab recognized in S2100. Details of the provision capabilities Pc are similar to those in S120 in the first embodiment.

In S2130 illustrated in FIG. 13, the search block 210 searches for the autonomous traveling device Ma whose provision capability Pc matches the required content Cd acquired in S2110 among the provision capabilities Pc represented by the service capability information acquired for the respective autonomous traveling devices Ma in the background area Ab in S2120. The acquisition of the matching degree R (see FIG. 15) and the extraction of the matching device Mam based on the matching degree R are similar to those in S130 in the first embodiment.

In S2140 illustrated in FIG. 13, the search block 210 causes the display unit 2002 of the mobile terminal Mt to display the XR-enhanced image Ipe that highlights the matching device Mam found in S2130 as illustrated in FIG. 15. At this time, the XR-enhanced image Ipe is superimposed and displayed on a background video Ib showing the background area Ab. The background video Ib is acquired based on, for example, sensing information acquired by the sensor unit 4 such as a camera or the three-dimensional spatial information Ti acquired from the infrastructure database Di. As the background video Ib, primary video data obtained by imaging the background area Ab may be used, or secondary video data obtained by processing the primary data may be used.

In S2140, as illustrated in FIG. 15, the XR capability images Ip, which are candidates for the XR-enhanced images Ipe, are superimposed and displayed on the background video Ib by the display unit 2002 to notify the provision capabilities Pc of the respective autonomous traveling device Mas for the user service corresponding to the required content Cd. In particular, the XR capability image Ip is superimposed and displayed while being aligned with the corresponding autonomous traveling device Ma in the background video Ib to notify the matching degree R acquired in S2130 together with the provision capability Pc.

A superimposed display position of the XR capability image Ip in S2140 is adjusted to a position around a position where the autonomous traveling device Ma is shown in the background video Ib based on, for example, the sensing information acquired by at least one of the sensor units 2003 and 4 and/or the three-dimensional spatial information Ti obtained from the infrastructure database Di. At this time, the background area Ab shown in the background video Ib on which the XR capability image Ip is superimposed and displayed may be fixed to the area recognized in S2100 or may be updated in accordance with S2100 by the viewpoint movement of the user Us. In S2140 described above, the extraction of the provision capability Pc corresponding to the required content Cd and the setting and display of the images Ip and Ipe are similar to those in S140 in the first embodiment.

In S2150 illustrated in FIG. 13, the search block 210 determines whether any autonomous traveling device Ma in the background area Ab is selected by the user Us in response to the superimposed display in S2140. At this time, the presence or absence of the selection made by the user Us is recognized based on the sensing information acquired by the mobile terminal Mt. Therefore, the sensing information for recognizing the presence or absence of selection made by the user Us is input into the sensor unit 2003 as the intention data of the user Us and is acquired through the mobile terminal Mt. Details of the selection input of the autonomous traveling device Ma are similar to those in S150 in the first embodiment.

When an affirmative determination is made by recognizing the selection by the user Us in S2150, S2160 is executed as illustrated in FIG. 13. In S2160, the drive control block 220 (see FIG. 12) provides a user service of a type corresponding to the required content Cd by controlling the drive of the autonomous traveling device Ma selected in S2150 in the background area Ab. Details of the provided user service and driving are similar to those in S160 in the first embodiment.

In S2150 described above, a negative determination is made, for example, when the user Us does not execute the selection input during a period from the start of the execution to the elapse of the set time, or when the user Us inputs an intention that there is no autonomous traveling device Ma required to be selected. In this case, in response to determining that the selection made by the user Us for the autonomous traveling device Ma in the background area Ab is rejected, S2170 is executed as illustrated in FIGS. 13 and 14.

In S2170 illustrated in FIG. 14, the search block 210 determines whether there is an autonomous traveling device Ma waiting within a set distance from the user Us outside the recognized background area Ab. At this time, the recognition of the presence or absence is similar to that in S170 in the first embodiment.

When an affirmative determination is made in S2170, S2180 is executed as illustrated in FIG. 14. In S2180, the search block 210 acquires additional capability information representing the provision capabilities Pc of the user service, which are associated with the autonomous traveling devices Ma whose presence is recognized in S2170 and which are waiting outside the background area Ab in accordance with S120 and S180 in the first embodiment.

In S2190 illustrated in FIG. 14, the search block 210 searches for the matching devices Mam whose the provision capabilities Pc represented by the additional capability information acquired for the respective autonomous traveling devices Ma outside the background area Ab in S2180 match the required content Cd acquired in S2110. The searching at this time is similar to that in S190 in the first embodiment based on the matching degree R.

In S2200 illustrated in FIG. 14, the search block 210 notifies the provision capabilities Pc represented by the additional capability information acquired for the respective autonomous traveling devices Ma outside the background area Ab in S2180. In S2200, the display unit 2002 of the mobile terminal Mt superimposes and displays the additional capability images Ia illustrated in FIG. 16 on the background video Ib in the background area Ab to implement such a notification in accordance with the XR capability image Ip.

In S2200, particularly, the additional capability image Ia is superimposed and displayed on, for example, an aerial area or a ground area shown in the background video Ib to notify the matching degree R acquired in S2190 together with the provision capability Pc. The additional capability image Ia may notify at least one of a direction from the user Us, a distance from the user Us, and an arrival time to the user Us by calling, for example, regarding the existence position of the corresponding autonomous traveling device Ma. The additional capability image Ia may be set as the additional enhanced image Iae that highlights the matching device Mam found in S2190 (in the example of FIG. 16, the autonomous traveling device Ma for which the existence position is displayed as “robot, 3 meters to the right”) in accordance with the XR-enhanced image Ipe. The additional capability image Ia may be superimposed and displayed at a fixed relative position with respect to the screen of the display unit 2002 showing the background video Ib of the background area Ab, or may be superimposed and displayed as the XR capability image Ip (including the XR-enhanced image Ipe for the matching device Mam) at a fixed relative position with respect to the autonomous traveling device Ma shown in the background video Ib of the background area Ab. In any of these cases, the background area Ab shown in the background video Ib on which the additional capability image Ia is superimposed and displayed may be fixed to the area recognized in S2100 or may be updated in accordance with S2100 by the viewpoint movement of the user Us.

In S2210 illustrated in FIG. 14, the search block 210 determines, in accordance with S2150, whether any autonomous traveling device Ma outside the background area Ab is selected by the user Us in response to the superimposed display in S2200. As a result, when an affirmative determination is made by recognizing the selection made by the user Us, S2220 is executed. In S2220, the drive control block 220 performs control to drive the autonomous traveling device Ma selected in S2210 into the background area Ab in order to provide a user service corresponding to the required content Cd in accordance with S2160. In other words, in S2220, the service of the required content Cd can be provided by controlling the driving of the selected autonomous traveling device Ma into the background area Ab.

In the processing flow illustrated in FIGS. 13 and 14 described above, when the provision of the user service corresponding to the required content Cd is completed by either S2160 or S2220, the current execution ends. Meanwhile, when a negative determination is made in any one of S2170 and S2210, the current execution of the processing flow may be completed after an XR notification image notifying an unsuccessful search result is superimposed and displayed on the background video Ib of the background area Ab. In either case, after the current execution is completed, the next execution of the processing flow is started by acquiring the next service request input through the sensor unit 2003 of the mobile terminal Mt.

### (Effects)

The effects of the second embodiment described above will be described below.

According to the second embodiment, the service capability information representing the provision capabilities Pc of the user service, which are associated with the autonomous traveling devices Ma waiting in the background area Ab serving as the display background from the mobile terminal Mt carried by the user Us to the user Us, is acquired. Therefore, when the required content Cd of the user service required by the user Us is acquired, attention is paid to the autonomous traveling device Ma whose provision capability Pc matches the required content Cd among provision capabilities Pc represented by the service capability information for the respective autonomous traveling devices Ma in the background area Ab. Accordingly, the XR-enhanced image Ipe in which the found autonomous traveling device Ma (specifically, the matching device Mam) whose capability Pc matches the required content Cd is highlighted is superimposed and displayed on the background video Ib showing the background area Ab for the selection of the device Ma made by the user Us. Therefore, it is possible to improve the search efficiency of the autonomous traveling device Ma capable of providing the user service satisfying the user request by being driven in the background area Ab.

Further, according to the second embodiment, the XR capability images Ip are superimposed and displayed on the background video Ib of the background area Ab while being aligned with the respective autonomous traveling devices Ma to notify the provision capabilities Pc corresponding to the required content Cd for the respective autonomous traveling devices Ma in the background area Ab. Therefore, among the XR capability images Ip of the respective autonomous traveling devices Ma, the XR capability image Ip, which highlights the corresponding autonomous traveling device Ma (specifically, the matching device Mam) whose matching degree R of the provision capability Pc with respect to the required content Cd is within the recommended range, is set as the XR-enhanced image Ipe. Accordingly, among the autonomous traveling devices Ma in the background area Ab whose provision capabilities Pc are notified, the user Us can appropriately select the autonomous traveling device Ma automatically found based on the matching degree R between the required content Cd and the provision capability Pc, for example, without making a reservation in advance. Therefore, not only the search efficiency of the autonomous traveling device Ma capable of providing the user service satisfying the user request but also the search accuracy can be improved by reducing the gap between the required content Cd and the provision capability Pc.

According to the second embodiment, the XR capability image Ip is superimposed and displayed on the background video Ib of the background area Ab to notify the matching degree R together with the provision capability Pc. Accordingly, the user Us can intuitively select the autonomous traveling device Ma highlighted together with the notification of the matching degree of the provision capability Pc with respect to the required content Cd among the autonomous traveling devices Ma whose provision capabilities Pc are notified in the background area Ab. Therefore, reliability can be given to the high-efficiency search of the autonomous traveling device Ma capable of providing the user service satisfying the user request.

Further, according to the second embodiment, in response to determining that the selection made by the user Us from among the autonomous traveling devices Ma in the background area Ab is rejected, the service capability information of the autonomous traveling device Ma waiting outside the background area Ab is acquired as the additional capability information. Therefore, the additional capability image Ia notifying the provision capability Pc represented by the additional capability information is superimposed and displayed on the background video Ib of the background area Ab. Accordingly, even when the autonomous traveling device Ma capable of providing the user service satisfying the user request is not found in the background area Ab, the search result of the device Ma expanded outside the background area Ab can be notified to the user Us. Therefore, it is possible to secure the fail-safe property in the high-efficiency search of the autonomous traveling device Ma and to give the user Us a sense of security.

Moreover, according to the second embodiment, the autonomous traveling device Ma selected by the user Us in response to the superimposed display of the additional capability image Ia is driven into the background area Ab to provide the user service. As a result, the user Us selects the autonomous traveling device Ma notified by the high-efficiency search outside the background area Ab, so that a user service satisfying the preference of the user Us can be provided by the device Ma automatically called into the background area Ab.

### Other Embodiments

Although multiple embodiments are described above, the present disclosure is not construed as being limited to these embodiments, and can be applied to various embodiments and combinations within a scope that does not depart from the gist of the present disclosure.

In a modification of the first or second embodiment, the dedicated computer constituting the control system 20 of the processing system 1 or the control system 2020 of the processing system 2001 may include at least one of a digital circuit and an analog circuit as a processor. The digital circuit is at least one type of, for example, an application specific integrated circuit (ASIC), a field programmable gate row (FPGA), a system on a chip (SOC), a programmable gate row (PGA), and a complex programmable logic device (CPLD). Such a digital circuit may also include a memory in which a program is stored.

In the modification of the first or second embodiment, the processing system 1 or 2001 may not be connected to the infrastructure system 6. In this modification, sensing information acquired by the connection elements Wt, Ma, or Mt with the processing system 1 or 2001 may be used instead of the three-dimensional spatial information Ti obtained from the infrastructure database Di.

In the modification of the first or second embodiment, the three-dimensional spatial information Ti not associated with the voxel Vi may be acquired by the processing system 1 or 2001 from the infrastructure database Di. In the modification of the first or second embodiment, two-dimensional grid information may be acquired by the processing system 1 or 2001 from the infrastructure database Di instead of the three-dimensional spatial information Ti.

In the modification of the first embodiment, when the mobile terminal Mt as in the second embodiment is connected to the processing system 1 and functions as a part of the wearable terminal Wt, the processing flow may be executed in response to the sensor unit 2003 constituting the part acquiring a service request input as the sensing information. In the modification of the first embodiment, when the mobile terminal Mt as in the second embodiment is connected to the processing system 1 and functions as a part of the wearable terminal Wt, the required content Cd may be acquired based on the sensing information acquired by the sensor unit 2003 constituting the part in S110 of the processing flow.

In the modification of the second embodiment, a smart watch or a video see-through or non-transmissive wearable terminal may be used as the mobile terminal Mt. In the modification of the second embodiment, when the wearable terminal Wt as in the first embodiment is connected to the processing system 2001 and functions as a part of the mobile terminal Mt, the processing flow may be executed in response to the sensor unit 3 constituting the part acquiring a service request input as the sensing information. In the modification of the second embodiment, when the wearable terminal Wt as in the first embodiment is connected to the processing system 2001 and functions as a part of the mobile terminal Mt, the required content Cd may be acquired based on the sensing information acquired by the sensor unit 3 constituting the part in S2110 of the processing flow.

In the modification of the first or second embodiment, S170 to S220 or S2170 to 2220 may be skipped, and thus the current execution of the processing flow may be ended in a case of negative determination in S150 or S2150. In S140 or S2140 according to the modification of the first or second embodiment, the matching degree R may be excluded from the notification target by the XR capability image Ip.

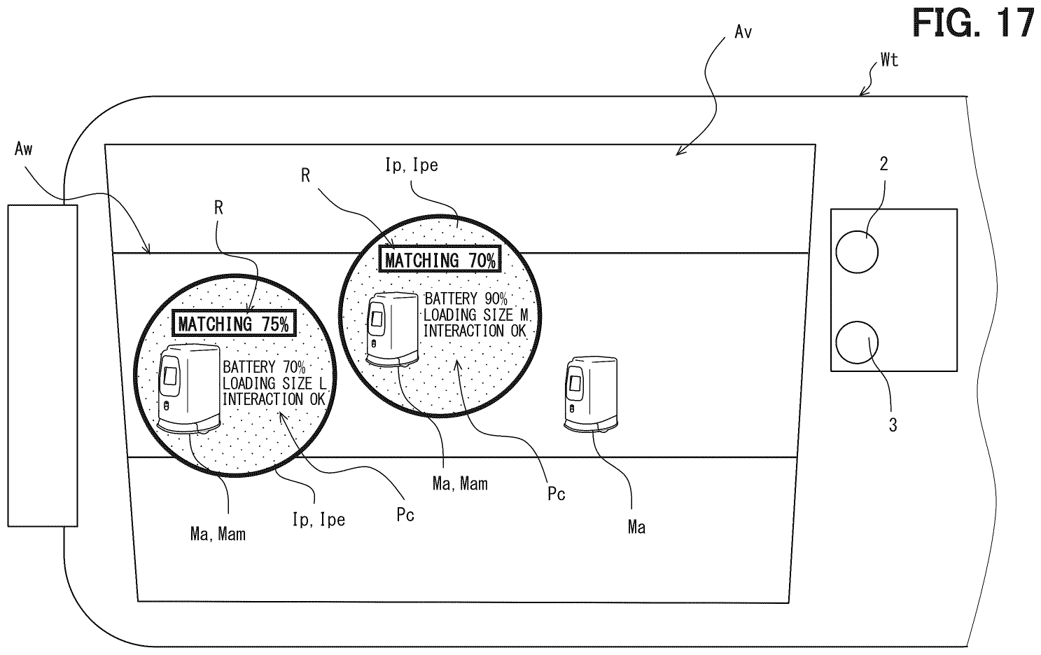

In S140 or S2140 according to the modification of the first or second embodiment, as illustrated in FIG. 17 (FIG. 17 illustrates the modification of the first embodiment), only the XR capability image Ip notifying the provision capability Pc of the matching device Mam, that is, only the XR capability image Ip set as the XR-enhanced image Ipe may be displayed. However, when the matching device Mam is not found in S130 or 2130 for such a display in the modification, S140 to S160 or S2140 to S2160 may be skipped, and S170 or S2170 may be executed.

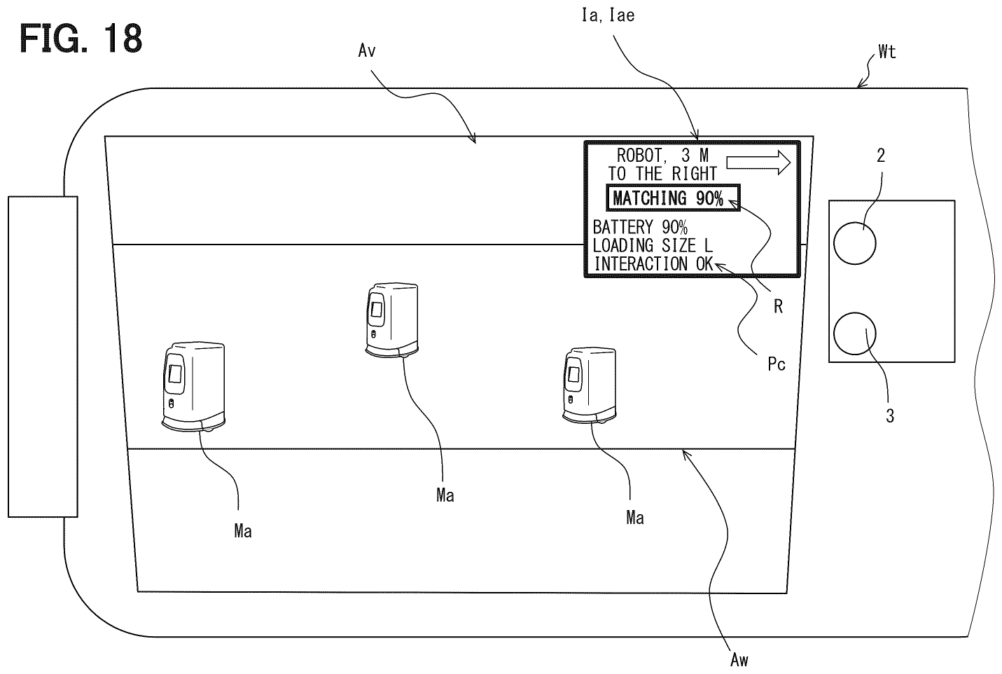

In S200 or S2200 according to the modification of the first or second embodiment, as illustrated in FIG. 18 (FIG. 18 illustrates the modification of the first embodiment), only the additional capability image Ia notifying the provision capability Pc of the matching device Mam, that is, only the additional capability image Ia set as the additional enhanced image Iae may be displayed. However, when the matching device Mam is not found in S190 or S2190 for such a display in the modification, S200 to S220 or S2200 to S2220 may be skipped, and the current execution of the processing flow may be ended.

In addition to the embodiments described above, the embodiments and modifications described above may be implemented in the form of a semiconductor device (for example, a semiconductor chip) as the processing system 1 or 2001 including at least one processor 24 and at least one memory 22 in the control system 20 or 2020.

What is claimed is:

1. A processing system for performing a service related processing, the service related processing being related to a user service provided to a user, the processing system comprising:
at least one processor with a memory storing computer program code, wherein the at least one processor with the memory is configured to:
acquire a required content of the user service required by the user;
acquire service capability information representing provision capabilities of the user service, the provision capabilities being associated with autonomous traveling devices waiting in a visual field area visually recognized by the user through a wearable terminal worn by the user;
search for a target autonomous traveling device whose provision capability matches the required content among the provision capabilities represented by the service capability information for the respective autonomous traveling devices in the visual field area;
display, in a superimposed manner, an extended reality (XR) enhanced image, which highlights the target autonomous traveling device, on the visual field area; and
provide the user service by driving, within the visual field area, the target autonomous traveling device selected by the user in response to superimposed display of the XR enhanced image.

2. The processing system according to claim 1, wherein
the superimposed display of the XR enhanced image includes setting, among XR capability images displayed in superimposed manner in the visual field area corresponding to respective autonomous traveling devices to notify the provision capabilities of respective autonomous traveling devices with respect to the required content, the XR capability image, which highlights the target autonomous traveling device having a matching degree of the provision capability with respect to the required content within a recommended range, as the XR enhanced image.

3. The processing system according to claim 2, wherein
the superimposed display of the XR enhanced image includes displaying the XR capability image in superimposed manner on the visual field area to notify the matching degree together with the provision capability.

4. The processing system according to claim 2, wherein
the acquiring of the service capability information further includes acquiring service capability information of an autonomous traveling device waiting outside the visual field area as additional capability information in response to determining that a selection made by the user for the target autonomous traveling device within the visual field area is rejected, and
the superimposed display of the XR enhanced image includes:
displaying, in superimposed manner, an additional capability image for notifying the provision capability represented by the additional capability information on the visual field area; and
driving the autonomous traveling device, which is selected by the user in response to the superimposed display of the additional capability image, into the visual field area to provide the user service.

5. The processing system according to claim 2, wherein
the superimposed display of the XR enhanced image includes, regarding the provision capability for providing the user service of a type represented by the required content, acquiring a matching degree correlated with a relevance rate scored for each type other than the type represented by the required content.

6. A processing system for performing a service related processing, the service related processing being related to a user service provided to a user, the processing system comprising:
at least one processor with a memory storing computer program code, wherein the at least one processor with the memory is configured to:
acquire a required content of the user service required by the user;
acquire service capability information representing provision capabilities of the user service, the provision capabilities being associated with autonomous traveling devices waiting in a background area, the background area being displayed by a mobile terminal carried by the user as a background with respect to the user;
search for a target autonomous traveling device whose provision capability matches the required content among the provision capabilities represented by the service capability information for the respective autonomous traveling devices in the background area;
display, in a superimposed manner, an extended reality (XR) enhanced image, which highlights the target autonomous traveling device, on a background video showing the background area; and
provide the user service by driving, within the background area, the target autonomous traveling device selected by the user in response to superimposed display of the XR enhanced image.

7. The processing system according to claim 6, wherein
the superimposed display of the XR enhanced image includes setting, among XR capability images displayed in superimposed manner on the background video corresponding to respective autonomous traveling devices to notify the provision capabilities of respective autonomous traveling devices with respect to the required content, the XR capability image, which highlights the target autonomous traveling device having a matching degree of the provision capability with respect to the required content within a recommended range, as the XR enhanced image.

8. The processing system according to claim 7, wherein
the superimposed display of the XR enhanced image includes displaying the XR capability image in superimposed manner on the background video to notify the matching degree together with the provision capability.

9. The processing system according to claim 7, wherein
the acquiring of the service capability information further includes acquiring service capability information of an autonomous traveling device waiting outside the background area as additional capability information in response to determining that a selection made by the user for the target autonomous traveling device within the background area is rejected, and
the superimposed display of the XR enhanced image includes:
displaying, in superimposed manner, an additional capability image for notifying the provision capability represented by the additional capability information on the background video; and
driving the autonomous traveling device, which is selected by the user in response to the superimposed display of the additional capability image, into the background area to provide the user service.

10. The processing system according to claim 7, wherein
the superimposed display of the XR enhanced image includes, regarding the provision capability for providing the user service of a type represented by the required content, acquiring a matching degree correlated with a relevance rate scored for each type other than the type represented by the required content.

11. A processing method to be executed by at least one processor to perform service related processing, the service related processing being related to a user service provided to a user, the processing method comprising:
acquiring a required content of the user service required by the user;
acquiring service capability information representing provision capabilities of the user service, the provision capabilities being associated with autonomous traveling devices waiting in a visual field area visually recognized by the user through a wearable terminal worn by the user;
searching for a target autonomous traveling device whose provision capability matches the required content among the provision capabilities represented by the service capability information for the respective autonomous traveling devices in the visual field area;
displaying, in superimposed manner, an extended reality (XR) enhanced image, which highlights the target autonomous traveling device, on the visual field area; and
providing the user service by driving, within the visual field area, the target autonomous traveling device selected by the user in response to superimposed display of the XR enhanced image.

12. A computer readable non-transitory storage medium storing a program comprising instructions to perform service related processing, the service related processing being related to a user service provided to a user, the instructions comprising:
acquiring a required content of the user service required by the user;
acquiring service capability information representing provision capabilities of the user service, the provision capabilities being associated with autonomous traveling devices waiting in a visual field area visually recognized by the user through a wearable terminal worn by the user;
searching for a target autonomous traveling device whose provision capability matches the required content among the provision capabilities represented by the service capability information for the respective autonomous traveling devices in the visual field area;
displaying, in superimposed manner, an extended reality (XR) enhanced image, which highlights the target autonomous traveling device, on the visual field area; and
providing the user service by driving, within the visual field area, the target autonomous traveling device selected by the user in response to superimposed display of the XR enhanced image.

13. A processing method to be executed by at least one processor to perform service related processing, the service related processing being related to a user service provided to a user, the processing method comprising:
acquiring a required content of the user service required by the user;
acquiring service capability information representing provision capabilities of the user service, the provision capabilities being associated with autonomous traveling devices waiting in a background area, the background area being displayed by a mobile terminal carried by the user as a background with respect to the user;
searching for a target autonomous traveling device whose provision capability matches the required content among the provision capabilities represented by the service capability information for the respective autonomous traveling devices in the background area;
displaying, in superimposed manner, an extended reality (XR) enhanced image, which highlights the target autonomous traveling device, on a background video showing the background area; and
providing the user service by driving, within the background area, the target autonomous traveling device selected by the user in response to superimposed display of the XR enhanced image.

14. A computer readable non-transitory storage medium storing a program comprising instructions to perform service related processing, the service related processing being related to a user service provided to a user, the instructions comprising:
acquiring a required content of the user service required by the user;
acquiring service capability information representing provision capabilities of the user service, the provision capabilities being associated with autonomous traveling devices waiting in a background area, the background area being displayed by a mobile terminal carried by the user as a background with respect to the user;
searching for a target autonomous traveling device whose provision capability matches the required content among the provision capabilities represented by the service capability information for the respective autonomous traveling devices in the background area;
displaying, in superimposed manner, an extended reality (XR) enhanced image, which highlights the target autonomous traveling device, on a background video showing the background area; and
providing the user service by driving, within the background area, the target autonomous traveling device selected by the user in response to superimposed display of the XR enhanced image.
